(19) United States
(12) Patent Application Publication
(10) Pub. No.: US 2026/0042495 A1
(43) Pub. Date: Feb. 12, 2026

(54) DEPLOYABLE FLEXIBLE FABRIC SPOILER FOR VEHICLE

(71) Applicant: Magna Exteriors Inc., Aurora (CA)

(72) Inventors: Jeffrey Caraway, Oxford, MI (US); Braendon R. Lindberg, Metamora, MI (US)

(73) Assignee: Magna Exteriors Inc., Aurora, ON (CA)

(21) Appl. No.: 18/998,649

(22) PCT Filed: Aug. 1, 2023
(86) PCT No.: PCT/US2023/071397

§ 371 Date: Jan. 27, 2025

Related U.S. Application Data
(60) Provisional application No. 63/394,484, filed on Aug. 2, 2022.

(51) Int. Cl. B62D 35/00

(52) U.S. Cl. CPC B62D 35/007

(57) ABSTRACT

An active spoiler shade that uses fabric to deploy and to form to the vehicle body shape. The fabric is selectively operably driven by at least one actuator by operably moving a long extruded bar. A plastic roll off edge is operably adapted to support the fabric to match a predetermined body shape of the vehicle. A retractable lattice structure can support the fabric.

### CROSS-REFERENCE TO RELATED APPLICATIONS

This application is a PCT International Patent Application and claims benefit of United States Provisional Ser. No. 63/394,484, filed Aug. 2, 2022. The disclosure of the above application is incorporated herein by reference.

### FIELD OF THE INVENTION

The present invention relates to an active spoiler shade assembly adapted for attachment to a vehicle.

### BACKGROUND OF THE INVENTION

There is a considerable loss of aerodynamic efficiency in vehicles due to the airflow around a vehicle. Conventional structures, such as fixed panels, are known and do not meet desired requirements.

If fabric were to now be used instead, a challenge becomes how to properly support fabric between support areas and also matching up with the vehicle body.

Accordingly, providing the use of fabric to deploy and to form to the vehicle body shape instead of large plastic panels with linkages is desired.

### SUMMARY OF THE INVENTION

An active spoiler shade assembly including fabric that is driven by actuators linearly, by moving a long-extruded bar that can be bent. A plastic roll-off edge can support the fabric to match the body shape. A retractable lattice structure supports the fabric as well as straps on the underside of the fabric.

The overall purpose is to deploy fabric on the rear spoiler to manage the airflow rearward.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top view of an active spoiler shade assembly in an exemplary stowed position, in accordance with the present invention;

FIG. 2 is a top view of the active spoiler shade assembly in an exemplary deployed position, in accordance with the present invention;

FIG. 3 is a rear view of the active spoiler shade assembly in an exemplary stowed position, in accordance with the present invention;

FIG. 4 is a cross sectional view of the active spoiler shade assembly with fabric deployed, in accordance with aspects of the present invention;

FIG. 5 is a cross sectional view of the active spoiler shade assembly with fabric stowed, in accordance with aspects of the present invention;

FIG. 6 is a cross sectional view of the active spoiler shade assembly, in accordance with the present invention;

FIG. 7 is a plan view of an exemplary roll-off edge of the active spoiler shade operably adaptable to match predetermined vehicle body environments, in accordance with aspects of the present invention;

FIGS. 8-9 are cross sectional views of exemplary exterior trim including attachment to at least one actuator, in accordance with aspects of the present invention;

FIG. 10 is a cross sectional view of an exemplary lattice of the active spoiler shade, in accordance with aspects of the present invention;

FIG. 11 is a cross sectional view of an exemplary lattice of the active spoiler shade, in accordance with aspects of the present invention; and

FIG. 12 is a cross sectional view depicting exemplary deployable corner baffles, in accordance with aspects of the present invention.

### DETAILED DESCRIPTION OF THE PREFERRED EMBODIMENTS

The following description of the preferred embodiment(s) is merely exemplary in nature and is in no way intended to limit the invention, its application, or uses.

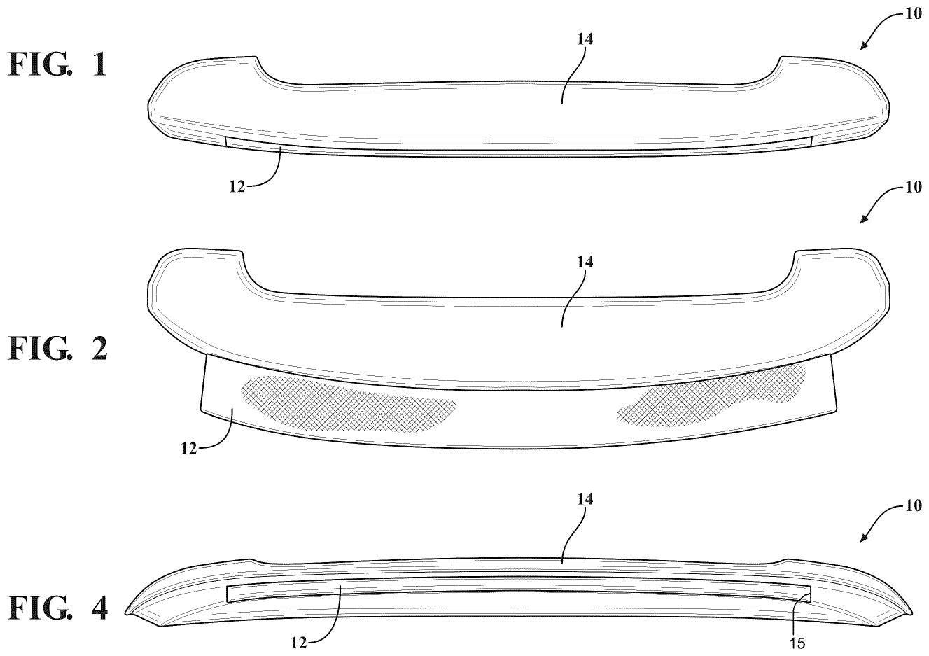

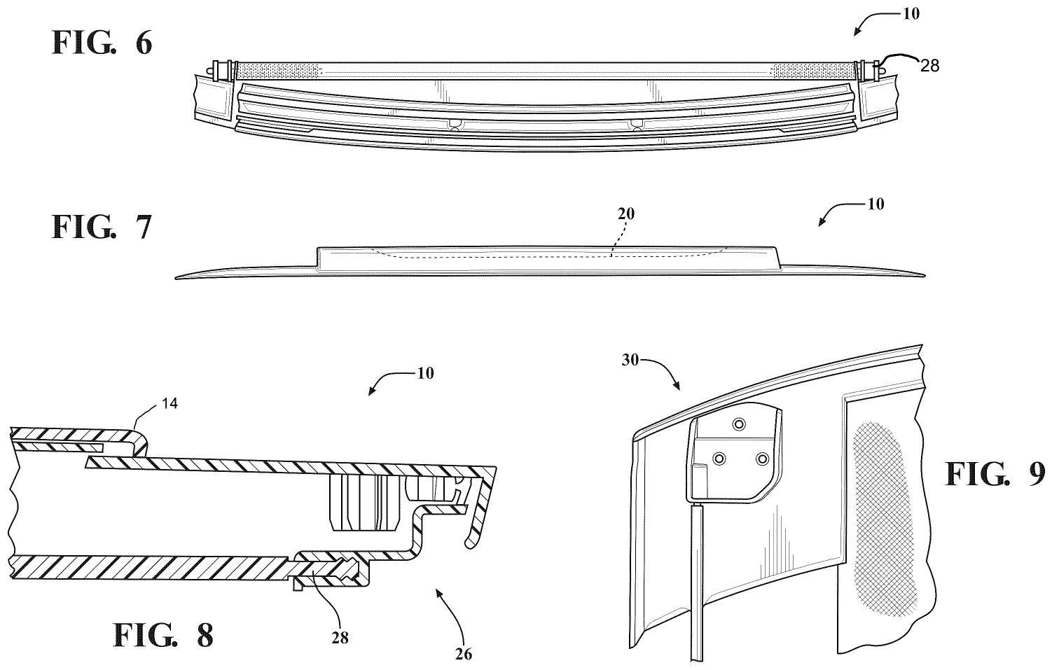

Referring to FIGS. 1-12 generally, there is provided an active spoiler shade assembly, indicated generally at 10, in accordance with the present invention, including at least one spoiler shade member 12 operably adapted to selectively deploy from at least one opening 15 in at least one spoiler body 14 and retract to a stowed position. The spoiler shade member 12 includes predetermined spoiler shade material. The spoiler shade member 12 preferably includes at least one predetermined fabric material. Fabric is used instead of plastic for effective selective elongation of the spoiler under predetermined conditions.

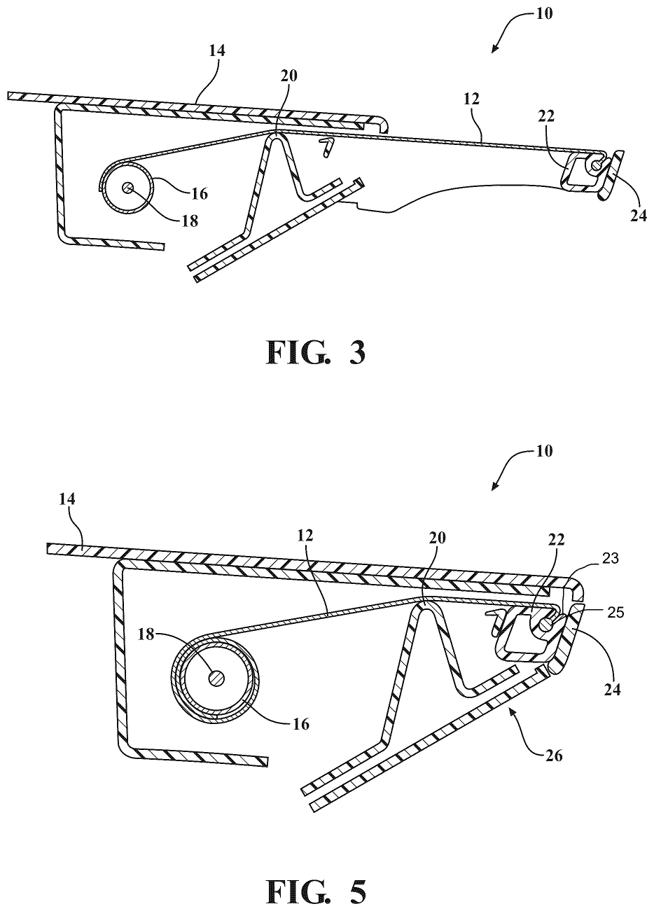

At least one tube 16 is provided with at least one spring 18 inside, which allows the predetermined material, e.g., fabric, to selectively operably wind up for stowing the spoiler shade material 12 in a stowed position (e.g., FIGS. 1, 4-5, and 8) and unwind to extend the length a predetermined amount for deployment of the spoiler shade material 12 to at least one deployed position (e.g., FIGS. 2-3 and 10). FIGS. 3 and 5 include a coiled spring 18 inside of the tube 16 that keeps the tube 16 pulling spoiler shade material 12 in tension. The spoiler shade material 12 is operably coupled toward one end to the tube 16.

At least one roll-off edge 20 is provided operably adapted to support the spoiler shade material 12 to generally keep the shape of the body, e.g., vehicle body. The roll-off edge 20 is preferably a molded predetermined shape suitable for the application to match any vehicle aesthetics. The roll-off edge 20 can be molded to match any vehicle body environment depending on the application, such that the spoiler shade material 12, e.g., fabric, substantially matches or compliments predetermined vehicle contour and dimensions. The roll-off edge 20 preferably operably keeps the spoiler shade material 12 taunt.

The at least one roll-off edge 20 is preferable a molded edge and is operable to support the spoiler shade material 12, e.g., soft material panel, to allow the material 12 to be taunt in coordination with the biased member 16 during retraction and deployment of the material 12, and the roll-off edge 20 is operably adapted to provide the spoiler shade material panel 12 with at least one predetermined contour and angle, e.g., aerodynamic shape, matching vehicle shape, etc.

The spoiler shade material 12 is deployable by the material, e.g., fabric, being operably held to at least one rod 22. The spoiler shade material 12 is operably coupled toward the other end 25 to the rod 22 (e.g., using at least one channel 23 in the rod 22, channel and welt arrangement, at least one fastener, adhesive, sewn extrusion/channel arrangement, welded, clamped, captured fabric, fabric lip in the channel 23, sewn lip, bracket, etc., and any combinations thereof), which rod 22 operably selectively pulls the spoiler shade material 12 generally outward to at least one deployed position. Preferably, the rod 22 is an aluminum extrusion.

At least one exterior trim 24 is provided to close out to the outside of the vehicle and operably matches the predetermined vehicle environment. The exterior trim 24 also operably attaches to the rod 22. Preferably, a gap is substantially eliminated from view when the assembly 10 is in the stowed position by the at least one exterior trim 24 closing out to the outside of the vehicle.

At least one actuator, indicated generally at 26 (e.g., preferably an actuator overmold), operably couples to the exterior trim 24 and/or rod 22 adapted to operably drive the system 10, e.g., between the stowed/closed position and at least one deployed/open position. The actuator 26 most preferably incorporates a linear actuator. Preferably, at least one drive rod portion 28 is provided. At least one predetermined exterior trim portion, indicated generally at 30, has predetermined shape and includes at least operable coupling to the actuator, e.g., linear actuator.

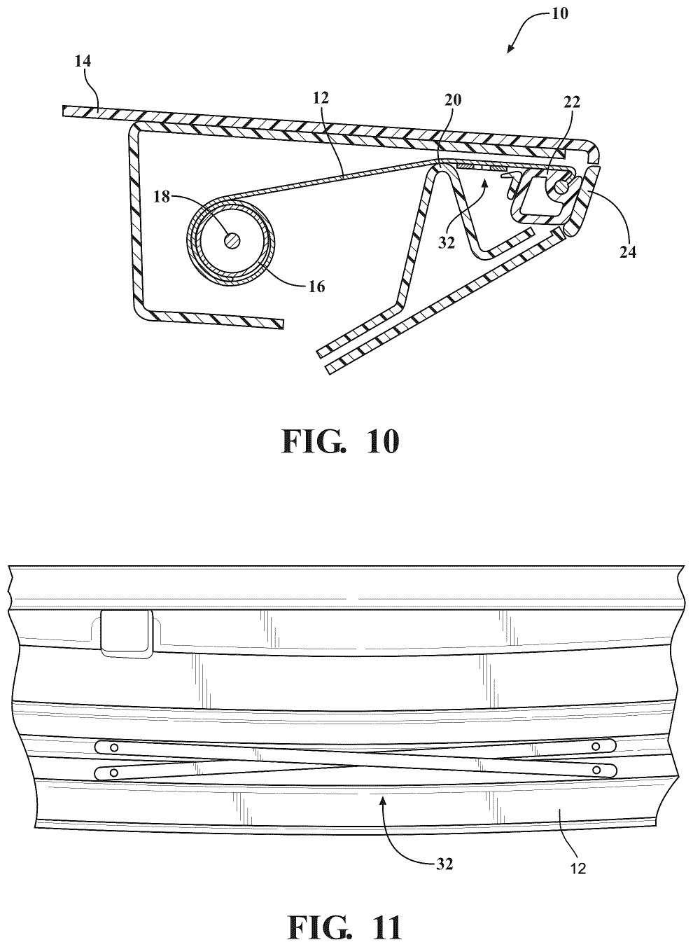

Referring more particularly to FIGS. 10-11, according to aspects of the present invention, there is provided at least one extending lattice, indicated generally at 32. The lattice supports the spoiler shade 12, e.g., fabric shade, cross-car to keep the predetermined desired shape of the shade 12. The lattice 32 can fold up (or otherwise suitably configure) and hold the predetermined shape of the spoiler shade 12 as it encounters wind and moving air.

The spoiler shade 12, e.g., of fabric material, is operably driven by at least one actuator linearly, e.g., see also 26, 28, FIGS. 5, 8, by moving the at least one rod 22, e.g., a long extruded bar, that can have a predetermined bend depending on the particular applications to meet predetermined vehicle body shapes. The roll off edge 20, preferably of plastic, is operably adapted to support the fabric 12 to match the body shape. The retractable lattice structure 32 operably supports the spoiler shade material 12 as well as any predetermined optional straps on the underside of the spoiler shade 12.

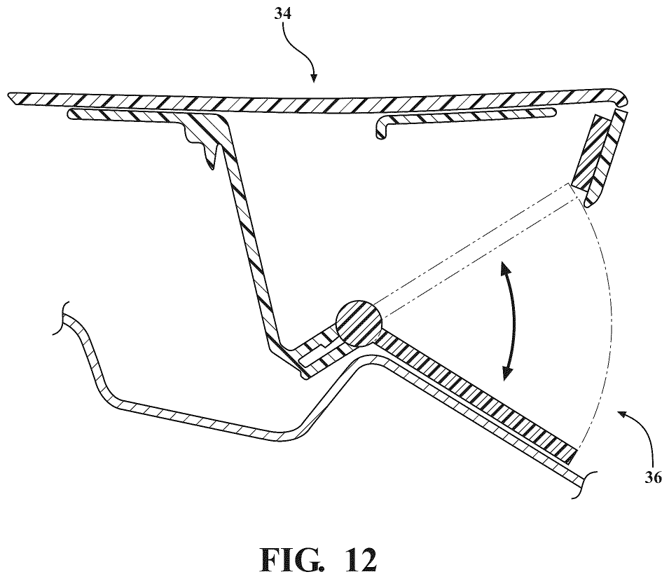

Referring more particularly to FIG. 12, according to aspects of the present invention, there is provided at least one corner cover, indicated generally at 34. Preferably, a pair of corner covers 34 is adapted to be connected at opposing positions adjacent opposing pillars of the vehicle. The corner cover 34 is movable between a stowed position and at least one deployed position, e.g., indicated generally by arrows in FIG. 12. The corner cover 34 is deployed to cover the corner with material to be deployed with the shade to block the corner air flow. Preferably, the assembly 10 incorporates D-pillar deployment of at least one corner baffle 34, that is deployed at predetermined speeds to reduce the drag on the vehicle. There is preferably one on each side of the vehicle, preferably in the D-pillar area. The corner baffles 34 operably deploy a sheet of material, indicated generally at 36, operable to divert wind rearward of the corner of the vehicle. Material sheet 36 and spoiler shade panel 12 may be one piece, according to aspects of the present invention.

Referring to FIGS. 1-12 generally, it is understood that the spoiler shade 12 material may be flexible, semi-flexible, one material or different materials, fabric, soft material, sail material, or any other suitable material and combinations thereof, depending on the application without departure from the scope of the present invention.

While a rearward spoiler and D-pillar area of deployment is shown and described throughout the application, it is understood that the system 10 is operably adaptable for any predetermined area of the vehicle depending on the application without departure from the scope of the present invention.

According to exemplary aspects of the present invention, the fabric 12 is retracted until the vehicle reaches a predetermined speed, e.g., of about 30 miles per hour, then the fabric 12 (and/or corners 34) are extended and stay deployed until the vehicle drops back down to below the predetermined speed, or until other predetermined conditions for continued deployment are no longer met.

The overall benefits of the present invention include, but are not limited to, deploying fabric on the rear spoiler to operably manage the airflow rearward. Fabric is preferably used instead of plastic for elongation of the spoiler. The tube with the use of spring inside allows the fabric to wind and unwind to extended length. The exterior trim closes out to the outside of the vehicle, attaches to the aluminum extruded rod. The aluminum rod has the fabric installed and pulls the fabric outward. The actuator overmold-operably attaches to the exterior trim and aluminum rod to drive the system. The roll off edge's molded shape matches the vehicle aesthetics. The extending lattice can fold up and hold the shape of the fabric from wind blowing on it. The corner cover is deployable to cover the corner with material to be deployed with the spoiler to block the corner air flow.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An active spoiler shade assembly operably adapted for a vehicle, comprising:
a spoiler body;
a soft material panel operably coupled to the spoiler body;
a tube that is operably biased by a predetermined member to allow the soft material panel to wind to a stowed position, and to unwind to extend said soft material panel to at least one deployed position;
wherein said soft material panel is selectively deployable from the spoiler body to manage airflow rearward under predetermined conditions.

2. The active spoiler shade assembly of claim 1, wherein a predetermined condition is a vehicle speed of at least about 30 miles per hour.

3. The active spoiler shade assembly of claim 1, wherein the soft material panel is at least one fabric material.

4. The active spoiler shade assembly of claim 1, wherein the soft material panel is not plastic.

5. The active spoiler shade assembly of claim 1, wherein the tube includes a spring inside that allows the soft material panel to wind and unwind to extended length.

6. The active spoiler shade assembly of claim 1, further comprising an exterior trim operably adapted to close out to the outside of the vehicle.

7. The active spoiler shade assembly of claim 1, further comprising an exterior trim that closes out to the outside of the vehicle, said exterior trim operably attaches to a rod coupled to the soft material panel operable to extend the soft material panel.

8. The active spoiler shade assembly of claim 1, further comprising a rod, wherein the soft material panel is operably connected to the rod operable for moving the soft material panel outward and to the stowed position.

9. The active spoiler shade assembly of claim 1, further comprising a rod, wherein the soft material panel is operably connected to the rod operable for moving the soft material panel between the stowed position and the at least one deployed position.

10. The active spoiler shade assembly of claim 9, wherein the rod is an aluminum extrusion.

11. The active spoiler shade assembly of claim 1, further comprising an actuator operable to drive the soft material panel between the deployed and stowed positions.

12. The active spoiler shade assembly of claim 11 wherein the actuator is operably overmolded to an exterior trim and rod to drive the soft material panel between the deployed and stowed positions.

13. The active spoiler shade assembly of claim 1, further comprising at least one roll-off edge operably shaped to engage the soft material panel to match a predetermined shape of the vehicle.

14. The active spoiler shade assembly of claim 1, further comprising at least one edge that is a predetermined molded shape to support the soft material panel and adapted to match predetermined vehicle contours and dimensions.

15. The active spoiler shade assembly of claim 1, further comprising at least one extending lattice that selectively holds the shape of the soft material panel from wind acting upon said soft material panel.

16. The active spoiler shade assembly of claim 1, further comprising at least one cover that operably deploys to cover a predetermined corner area with predetermined soft material to be deployed with the soft material panel to block the corner air flow.

17. An active spoiler shade assembly operably adapted for a vehicle, comprising:
a soft material panel operably coupled to a spoiler body;
a biased member that is operably biased by a coil spring adapted to selectively wind the soft material panel about the biased member to a stowed position, and to selectively unwind the soft material panel from the biased member to extend said soft material panel to at least one deployed position to manage airflow under predetermined conditions.

18. The active spoiler shade assembly of claim 17, further comprising at least one roll-off molded edge operable to support the soft material panel to allow said soft material panel to be taunt during retraction and deployment and operably adapted to provide said soft material panel with a predetermined contour and angle.

19. The active spoiler shade assembly of claim 17, further comprising at least one extending lattice that selectively holds the shape of the soft material panel from wind acting upon said soft material panel.

20. An active spoiler shade assembly operably adapted for a vehicle, comprising:
at least one actuator;
at least one rear spoiler body;
at least one soft material panel selectively deployable from an opening in said rear spoiler body;
at least one tube that is operably biased by a corresponding predetermined biasing member to allow the soft material panel to move to a stowed position, and that allows said actuator to selectively operably extend said soft material panel to at least one deployed position to manage airflow under predetermined conditions.
